(19) United States
(12) Patent Application Publication
(10) Pub. No.: US 2016/0083677 A1
(43) Pub. Date: Mar. 24, 2016

(54) STRUCTURED DETERGENT PARTICLES AND GRANULAR DETERGENT COMPOSITIONS CONTAINING THE SAME

(71) Applicant: The Procter & Gamble Company, Cincinnati, OH (US)

(72) Inventors: Rui SHEN, Beijing (CN); Paul R. MORT, III, Cincinnati, OH (US); Hong Sing TAN, Beijing (CN); Yuan ZHAO, Beijing (CN); Jianze MA, Beijing (CN)

(21) Appl. No.: 14/857,842

(22) Filed: Sep. 18, 2015

(30) Foreign Application Priority Data
Sep. 18, 2014 (WO) CN2014/086800
Aug. 5, 2015 (WO) CN2015/086111

(51) Int. Cl. C11D 17/06; C11D 3/065; C11D 3/10; C11D 1/22; C11D 3/08

(52) U.S. Cl. CPC C11D 17/06; C11D 1/22; C11D 3/08; C11D 3/10; C11D 3/065

(57) ABSTRACT

This relates to structured detergent particles with mid-level surfactant activity, which contain 35-50 wt % of a C₁₀-C₂₀ linear alkyl benzene sulphonate, 0.5-8 wt % of a hydrophilic silica, 35-70 wt % of a water-soluble alkaline metal carbonate, 0-5 wt % of a phosphate builder, and 0-5 wt % of a zeolite builder. Such structured detergent particles are free flowing with little or no moisture content (i.e., 0-3 wt % water), and are formed by a dry neutralization process without any subsequent drying.

### FIELD OF THE INVENTION

The present invention relates to granular detergent compositions. Particularly, it relates to granular detergent compositions containing free-flowing structured detergent particles with mid-level surfactant activity (e.g., 35 wt % to 50 wt %) and a low moisture content (e.g., 0 wt % to 3 wt %), which can be readily formed by a dry neutralization process without any subsequent drying.

### BACKGROUND OF THE INVENTION

Anionic surfactants containing linear alkylbenzene sulphonates (“LAS”) are one of the most commonly used cleaning actives in powder detergent formulations. Detergent granules containing LAS can be readily formed by various different agglomeration processes.

For example, the liquid acid precursor of LAS, which is the linear alkylbenzene sulphonic acid and is typically referred to as “HLAS,” can be mixed with an aqueous solution of sodium hydroxide (i.e., caustic) to form a substantially neutralized LAS paste, which is then mixed with other powder ingredients to form the detergent granules. Such LAS paste has a relatively high water content, because not only the sodium hydroxide solution introduces water into the mixture, but also the neutralization reaction between HLAS and NaOH generates water as a reaction by-product. Such relatively high water content must be subsequently removed from the detergent granules in order to preserve the free flow characteristic of the dry powder detergents and avoid undesirable “caking” of the finished product. Subsequent water removal is typically achieved by drying, which is an energy and capital-demanding process.

In order to avoid introducing too much water into the process that will require subsequent drying, a “dry” neutralization process has been developed. Specifically, the liquid HLAS is directly mixed with an excess amount of sodium carbonate particles (e.g., commercial soda ash) and other powder ingredients during agglomeration. Neutralization of HLAS occurs on the outer surface of the sodium carbonate particles, forming LAS and carbon dioxide gas with a small amount of water as by-products. The liquid HLAS functions as a binder during such agglomeration process. The small amount of water generated by the neutralization reaction is absorbed by the excess sodium carbonate and other dry powder ingredients, thereby reducing or completely eliminating the need for subsequent drying. However, the total surfactant content or surfactant activity of the LAS-based detergent granules so formed may be limited, i.e., to no more than 30%. This is because neutralization of HLAS can only occur at the outer surface of the sodium carbonate particles, but not inside of such particles. In other words, only a small portion of the sodium carbonate (i.e., those at the outer surface of the particles) is utilized to neutralize HLAS during the dry neutralization process. Consequently, a stoichiometrically excessive amount of sodium carbonate is required to completely neutralize the HLAS, resulting in detergent granules with a relatively high level of sodium carbonate and a relatively low surfactant content or activity.

WO9804670 discloses LAS-containing detergent granules having a relatively low surfactant content of 30% or less (see examples of WO9804670). Further, such detergent granules are formed by an agglomeration process which requires subsequent drying as an essential step.

There is therefore a need to provide detergent granules having higher surfactant activity and low moisture content, which can be formed by a simple dry neutralization process without the need for subsequent drying.

It would also be advantageous to provide LAS-based detergent granules having a reduced amount of oversized particles, which are undesirable from the processing point of view, in comparison with the conventional LAS-based detergent particles.

### SUMMARY OF THE INVENTION

The present invention discovers that the above-mentioned need can be readily met by a structured detergent particle that contains: (a) from about 35 wt % to about 50 wt % of an anionic surfactant that is a C₁₀-C₂₀ linear alkyl benzene sulphonate; (b) from about 0.5 wt % to about 8 wt % of a hydrophilic silica comprising less than 10 wt % of residue salt; (c) from about 40 wt % to about 60 wt % of a water-soluble alkaline metal carbonate; and (d) from 0 wt % to about 5 wt % of a phosphate builder, while the structured detergent particle is characterized by: (1) a particle size distribution Dw50 of from about 100 μm to about 1000 μm; (2) a bulk density of from about 400 to about 1000 g/L; and (3) a moisture content of from 0 wt % to about 3 wt %, and while the structured detergent particle is substantially free of phosphate.

Another aspect of the present invention relates to a structured detergent particle that consists essentially of: (a) from about 35 wt % to about 50 wt % of an anionic surfactant that is a C₁₀-C₂₀ linear alkyl benzene sulphonate; (b) from about 0.5 wt % to about 8 wt % of a hydrophilic silica comprising less than 10 wt % of residue salt; and (c) from about 40 wt % to about 60 wt % of a water-soluble alkaline metal carbonate, while the structured detergent particle is characterized by: (1) a particle size distribution Dw50 of from about 100 μm to about 1000 μm; (2) a bulk density of from about 400 to about 1000 g/L; and (3) a moisture content of from 0 wt % to about 3 wt %.

The present invention also relates to a granular detergent composition containing the above-described structured detergent particles, which are preferably present in an amount ranging from about 0.5% to about 20%, preferably from about 1% to about 15% and more preferably from about 4% to about 12%, by total weight of the granular detergent composition.

Such a granular detergent composition may further include, in combination with the structured detergent particles, composite detergent particles that contain both LAS and alkylethoxy sulfate (AES). Specifically, such composite detergent particles may contain a C₁₀-C₂₀ linear alkyl benzene sulphonate surfactant and a C₁₀-C₂₀ linear or branched alkylethoxy sulfate surfactant, while the composite detergent particles are characterized by a particle size distribution Dw50 of from about 100 μm to about 1000 μm and a total surfactant content ranging from about 50% to about 80% by total weight thereof. In a particularly preferred but not necessary embodiment of the present invention, each of the composite detergent particle comprises a core particle and a coating layer, while the core particle comprises a mixture of silica, the C₁₀-C₂₀ linear alkyl benzene sulphonate surfactant and optionally the C₁₀-C₂₀ linear or branched alkylethoxy sulfate surfactant, while the coating layer comprises the C₁₀-C₂₀ linear or branched alkylethoxy sulfate surfactant, and. The composite detergent particles are preferably present in the amount ranging from about 1% to about 30%, preferably from about 1.5% to about 20% and more preferably from about 2% to about 10%, by total weight of the granular detergent composition.

These and other aspects of the present invention will become more apparent upon reading the following drawings and detailed description of the invention.

### DETAILED DESCRIPTION OF THE INVENTION

As used herein, articles such as “a” and “an” when used in a claim, are understood to mean one or more of what is claimed or described. The terms “include”, “includes” and “including” are meant to be non-limiting.

The term “structured detergent particle” as used herein refers to a particle comprising a hydrophilic silica and a cleaning active, preferably a structured agglomerate.

As used herein, the term “a granular detergent composition” refers to a solid composition, such as granular or powder-form all-purpose or heavy-duty washing agents for fabric, as well as cleaning auxiliaries such as bleach, rinse aids, additives, or pre-treat types.

As used herein, the term “composite detergent granule,” “composite detergent particle,” “hybrid detergent granule,” or “hybrid detergent particle” refer to particles containing two or more surfactants, which are preferably located in different and discrete regions in the particles.

The term “bulk density” as used herein refers to the uncompressed, untapped powder bulk density, as measured by the Bulk Density Test specified hereinafter.

The term “particle size distribution” as used herein refers to a list of values or a mathematical function that defines the relative amount, typically by mass or weight, of particles present according to size, as measured by the Sieve Test specified hereinafter.

The term “residue salt” as used herein refers to salts formed during the silica manufacturing process, for example as by-products of silica precipitation.

As used herein, the term “substantially neutralized” refers to at least 95 wt % neutralization of the HLAS.

As used herein, the term “substantially free of” means that that the component of interest is present in an amount less than 0.1% by weight.

As used herein, the term “consisting essentially of” means that there are no intentionally added components beyond those explicitly listed, but ingredients that are present as impurities or byproducts of others may be included.

As used therein, the term “water-swellable” refers to the capability of a raw material to increase volumetrically upon hydration.

In all embodiments of the present invention, all percentages or ratios are calculated by weight, unless specifically stated otherwise. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Structured Detergent Particles

The present invention relates to a structured detergent particle that comprises from about 35% to about 50% of an anionic surfactant that is a C₁₀-C₂₀ linear alkyl benzene sulphonate (LAS), from about 0.5% to 8% of hydrophilic silica, and from about 40% to about 60% of a water-soluble alkaline metal carbonate, by total weight of such structured detergent particles.

Without being bound by any theory, it is believed that the combination of LAS, silica and carbonate in the amounts specified hereinabove enables the formation of free-flowing, low moisture content structured detergent particles by a simple dry neutralization process without the need for subsequent drying. Further, the structured detergent particles so formed are characterized by a significantly reduced amount of oversized particles therein (i.e., particles having a particle size greater than 1180 μm), which are undesirable for incorporating into the finished detergent products and therefore need to be removed prior thereto.

The C₁₀-C₂₀ linear alkyl benzene sulphonate or LAS are neutralized salts of C₁₀-C₂₀ linear alkyl benzene sulphonic acid, such as sodium salts, potassium salts, magnesium salts, etc. Preferably, LAS is a sodium salt of a linear C₁₀-C₂₀ alkyl benzene sulphonic acid, and more preferably a sodium salt of a linear C₁₁-C₁₃ alkyl benzene sulphonic acid. In a specific embodiment of the present invention, the structured detergent particles of the present invention comprise LAS in an amount ranging from about 40% to about 45%, preferably from about 41% to about 44%, more preferably from about 42% to about 43%, by totally weight of the structured detergent particles.

Such structured detergent particles may contain only LAS as the sole surfactant, according to a particularly preferred embodiment of the present invention.

In alternative embodiments of the present invention, such structured detergent particles may also contain one or more additional surfactants in addition, e.g., to provide a combination of two or more different anionic surfactants, a combination of one or more anionic surfactants with one or more nonionic surfactants, a combination of one or more anionic surfactants with one or more cationic surfactants, or a combination of all three types of surfactants (i.e., anionic, nonionic, and cationic).

Additional anionic surfactants suitable for forming the structured detergent particles of the present invention can be readily selected from the group consisting of C₁₀-C₂₀ linear or branched alkyl alkoxylated sulphates, C₁₀-C₂₀ linear or branched alkyl sulfates, C₁₀-C₂₀ linear or branched alkyl sulphonates, C₁₀-C₂₀ linear or branched alkyl phosphates, C₁₀-C₂₀ linear or branched alkyl phosphonates, C₁₀-C₂₀ linear or branched alkyl carboxylates, and salts and mixtures thereof.

Nonionic and/or cationic surfactants can also be used in addition to anionic surfactant in forming the structured detergent particles of the present invention. Suitable nonionic surfactants are selected from the group consisting of C₈-C₁₈ alkyl alkoxylated alcohols having a weight average degree of alkoxylation from about 1 to about 20, preferably from about 3 to about 10, and most preferred are C₁₂-C₁₈ alkyl ethoxylated alcohols having a weight average degree of alkoxylation of from about 3 to about 10; and mixtures thereof. Suitable cationic surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Hydrophilic silica is incorporated into the structured detergent particles of the present invention to enable formation of such particles in a free flowing form by a single dry neutralization process without subsequent drying.

The hydrophilic silica powder raw material used herein has relatively small dry particle size and low residue salt content. Specifically, the silica particles have a dry particle size distribution Dv50 ranging from about 0.1 μm to about 100 μm, preferably from about 1 μm to about 40 μm, more preferably from about 2 μm to about 20 μm, and most preferably from 4 μm to about 10 μm. The residue salt content in the hydrophilic silica is less than about 10%, preferably less than about 5%, more preferably less than about 2% or 1% by total weight of said silica. In a most preferred embodiment, the hydrophilic silica is substantially free of any residue salt. Presence of too much residue salt in the hydrophilic silica may reduce the overall structuring capacity of the silica.

Amorphous synthetic silica can be manufactured using a thermal or pyrogenic or a wet process. The thermal process leads to fumed silica. The wet process to either precipitated silica or silica gels. Either fumed silica or precipitated silica can be used for practice of the present invention. The pH of the hydrophilic silica of the present invention is normally from about 5.5 to about 9.5, preferably from about 6.0 to about 7.0. Surface area of the hydrophilic silica may range preferably from about 100 to about 500 m²/g, more preferably from about 125 to about 300 m²/g and most preferably from about 150 to about 200 m²/g, as measured by the BET nitrogen adsorption method.

Silica has both internal and external surface area, which allows for easy absorption of liquids. Hydrophilic silica is especially effective at adsorbing water. Swelling of dried hydrophilic silica upon contact with excess water to form hydrogel particles can be observed by optical microscopy and can be measured quantitatively using particle size analysis by comparing the particle size distribution of the fully hydrated material (i.e., in a dilute suspension) with that of the dried powder. Generally, precipitated hydrophilic silica can absorb water in excess of 2 times of its original weight, thereby forming swollen hydrogel particles having a Swollen Factor of at least 5, preferably at least 10, and more preferably at least 30. Therefore, the hydrophilic silica used in the present invention is preferably amorphous precipitated silica. A particularly preferred hydrophilic precipitated silica material for practice of the present invention is commercially available from Evonik Corporation under the tradename Sipernat®340.

Upon hydration, i.e., when the structured detergent particles of the present invention come into contact with water or other laundry liquor during a washing cycle, the hydrophilic silica as described hereinabove swells up significantly in volume to form swollen silica particles, which are characterized by a particle size distribution Dv50 of from about 1 μm to about 100 μm, preferably from about 5 μm to about 80 μm, more preferably from 10 μm to 40 μm, and most preferably from about 15 μm to about 30 μm. More specifically, the swollen silica particles formed by the hydrophilic silica upon hydration are characterized by a particle size distribution of Dv10 ranging from about 1 μm to about 30 μm, preferably from about 2 μm to about 15 μm, and more preferably from about 4 μm to about 10 μm; and Dv90 ranging from about 20 μm to about 100 μm, preferably from about 30 μm to about 80 μm, and more preferably from about 40 μm to about 60 μm.

The hydrophilic silica is present in the structured detergent particles of the present invention in an amount ranging from about 0.5% to about 8%, preferably from about 1% to about 7%, more preferably from about 2% to about 6%, and most preferably from about 3% to about 5%, by total weight of the structured detergent particles.

In addition to LAS and hydrophilic silica, the structured detergent particles of the present invention also comprise one or more water-soluble alkaline metal carbonates. Suitable alkali metal carbonates that can be used for practice of the present invention include, but are not limited to, sodium carbonate, potassium carbonate, sodium bicarbonate, and potassium bicarbonate (which are all referred to as “carbonates” or “carbonate” hereinafter). Sodium carbonate is particularly preferred. Potassium carbonate, sodium bicarbonate, and potassium bicarbonate can also be used.

The water-soluble alkali metal carbonate may be used in the structured detergent particles at an amount ranging from about 40% to about 60%, and more preferably from about 45% to about 55%, by total weight of the structured detergent particles.

The water-soluble alkali metal carbonate is in a particulate form and is preferably characterized by a particle size distribution Dw50 ranging from about 10 microns to about 100 microns, more preferably from about 50 microns to about 95 microns, and most preferably from about 60 microns to about 90 microns. Particle size of the carbonate may be reduced by a milling, grinding or a comminuting step down to a Dw50 range of from about 10 microns to about 35 microns, using any apparatus known in the art for milling, grinding or comminuting of granular or particulate compositions. In a particularly preferred embodiment of the present invention, the structured particles comprise unground sodium carbonate particles having Dw50 ranging from about 60 microns to about 80 microns in an amount ranging from about 7 wt % to about 20 wt %, and ground sodium carbonate particles having Dw50 ranging from about 10 microns to about 25 microns in an amount ranging from about 28 wt % to about 44 wt %.

The structured particles of the present invention may comprise other cleaning actives, such as builders, chelants, polymers, enzymes, bleaching agents, and the like.

For example, the structured particles may contain from 0% to about 30%, preferably from 0% to about 10%, more preferably from 0% to about 5% and most preferably from 0 wt % to about 1%, of a zeolite builder, as measured by total weight of such structured detergent particles. It may also contain from 0% to about 5%, more preferably from 0% to about 3%, and most preferably from 0% to about 1%, of a phosphate builder, as measured by total weight of the structured detergent particles. Preferably, but not necessarily, the structured detergent particle of the present invention contains little or no zeolite and little or no phosphate. It is particularly preferable for the structured detergent particle of the present invention to be substantially free of any phosphate builder.

The moisture content of such structured detergent particle is no more than 3% (i.e., from 0-3%), preferably no more than 2.5% (i.e., from 0-2.5%), more preferably no more than 2% (i.e., 0-2%), and most preferably no more than 1.5% (i.e., 0-1.5%) by total weight of the particles.

The structured detergent particles of the present invention have a particle size distribution particularly Dw50 of from 100 μm to 1000 μm, preferably from 250 μm to 800 μm, and more preferably from 300 μm to 600 μm. The bulk density of such structured detergent particles may range from 400 g/L to 1000 g/L, preferably from 500 g/L to 850 g/L, more preferably from 550 g/L to 700 g/L.

### Granular Detergent Composition

The above-described structured detergent particles may be formulated into a granular detergent composition in an amount ranging from 0.5% to 20%, preferably from 1% to 15%, and more preferably from 4% to 12% by total weight of the granular detergent composition.

The granular detergent composition may comprise one or more other detergent particles, i.e., independent of the structured detergent particles as described hereinabove.

For example, the granular detergent composition can include one or more composite detergent particles containing both LAS and alkylethoxy sulfate (AES) surfactants. In one embodiment, the LAS and AES surfactants can be simply mixed together, preferably with one or more solid carrier such as silica or zeolite. In a preferred but not necessary embodiment, the LAS and AES components of the composite detergent granules are arranged in a unique spatial relationship, i.e., with LAS in the core and AES in the coating layer, so to provide protection of the LAS component by AES against the Ca²⁺ ions in hard water washing environments, thereby maximizing the water hardness tolerance of the surfactants. Specifically, the composite detergent particles may each comprise a core particle and a coating layer over the core particle, while the core particle contains a mixture of silica, LAS and optionally AES; the coating layer comprises AES. The composite detergent particles are characterized by a particle size distribution Dw50 of from about 100 μm to about 1000 μm and a total surfactant content ranging from about 50% to about 80% by total weight thereof. The composite detergent particles are preferably characterized by a LAS-to-AES weight ratio of from 3:1 to 1:3, preferably from 2.5:1 to 1:2.5, and more preferably from 1.5:1 to 1:1.5.

Such composite detergent particles can be provided in the granular detergent composition in an amount ranging from about 1% to about 30%, preferably from about 1.5% to about 20% and more preferably from about 2% to about 10%, by total weight of said granular detergent composition.

In addition to the structured detergent particles and the composite detergent particles as described hereinabove, the granular detergent compositions of the present invention may also contain one or more other detergent particles, such as detergent particles formed by spray-drying, agglomerates of cleaning polymers, aesthetic particles, and the like.

The granular detergent compositions of the present invention may further comprise a water-swellable cellulose derivative. Suitable examples of water-swellable cellulose derivatives are selected from the group consisting of substituted or unsubstituted alkyl celluloses and salts thereof, such as ethylcellulose, hydroxyethyl cellulose, hydroxypropyl methyl cellulose, methyl cellulose, carboxyl methyl cellulose (CMC), cross-linked CMC, modified CMC, and mixtures thereof. Preferably, such cellulose derivative materials can rapidly swells up within 10 minutes, preferably within 5 minutes, more preferably within 2 minutes, even more preferably within 1 minute, and most preferably within 10 seconds, after contact with water. The water-swellable cellulose derivatives can be incorporated into the structured particles of the present invention together with the hydrophilic silica, or they can be incorporated into the granular detergent compositions independent of the structured particles, in an amount ranging from 0.1% to 5% and preferably from 0.5% to 3%. Such cellulose derivatives may further enhance the mechanical cleaning benefit of the granular detergent compositions of the present invention.

The granular detergent compositions may optionally include one or more other detergent adjunct materials for assisting or enhancing cleaning performance, treatment of the substrate to be cleaned, or to modify the aesthetics of the detergent composition. Illustrative examples of such detergent adjunct materials include: (1) inorganic and/or organic builders, such as carbonates (including bicarbonates and sesquicarbonates), sulphates, phosphates (exemplified by the tripolyphosphates, pyrophosphates, and glassy polymeric meta-phosphates), phosphonates, phytic acid, silicates, zeolite, citrates, polycarboxylates and salts thereof (such as mellitic acid, succinic acid, oxydisuccinic acid, polymaleic acid, benzene 1,3,5-tricarboxylic acid, carboxymethyloxysuccinic acid, and soluble salts thereof), ether hydroxypolycarboxylates, copolymers of maleic anhydride with ethylene or vinyl methyl ether, 1,3,5-trihydroxy benzene-2,4,6-trisulphonic acid, 3,3-dicarboxy-4-oxa-1,6-hexanedioates, polyacetic acids (such as ethylenediamine tetraacetic acid and nitrilotriacetic acid) and salts thereof, fatty acids (such as C₁₂-C₁₈ monocarboxylic acids); (2) chelating agents, such as iron and/or manganese-chelating agents selected from the group consisting of amino carboxylates, amino phosphonates, polyfunctionally-substituted aromatic chelating agents and mixtures therein; (3) clay soil removal/anti-redeposition agents, such as water-soluble ethoxylated amines (particularly ethoxylated tetraethylene-pentamine); (4) polymeric dispersing agents, such as polymeric polycarboxylates and polyethylene glycols, acrylic/maleic-based copolymers and water-soluble salts thereof of, hydroxypropylacrylate, maleic/acrylic/vinyl alcohol terpolymers, polyethylene glycol (PEG), polyaspartates and polyglutamates; (5) optical brighteners, which include but are not limited to derivatives of stilbene, pyrazoline, coumarin, carboxylic acid, methinecyanines, dibenzothiphene-5,5-dioxide, azoles, 5- and 6-membered-ring heterocycles, and the like; (6) suds suppressors, such as monocarboxylic fatty acids and soluble salts thereof, high molecular weight hydrocarbons (e.g., paraffins, haloparaffins, fatty acid esters, fatty acid esters of monovalent alcohols, aliphatic C₁₈-C₄₀ ketones, etc.), N-alkylated amino triazines, propylene oxide, monostearyl phosphates, silicones or derivatives thereof, secondary alcohols (e.g., 2-alkyl alkanols) and mixtures of such alcohols with silicone oils; (7) suds boosters, such as C₁₀-C₁₆ alkanolamides, C₁₀-C₁₄ monoethanol and diethanol amides, high sudsing surfactants (e.g., amine oxides, betaines and sultaines), and soluble magnesium salts (e.g., MgCl₂, MgSO₄, and the like); (8) fabric softeners, such as smectite clays, amine softeners and cationic softeners; (9) dye transfer inhibiting agents, such as polyvinyl pyrrolidone polymers, polyamine N-oxide polymers, copolymers of N-vinylpyrrolidone and N-vinylimidazole, manganese phthalocyanine, peroxidases, and mixtures thereof; (10) enzymes, such as proteases, amylases, lipases, cellulases, and peroxidases, and mixtures thereof; (11) enzyme stabilizers, which include water-soluble sources of calcium and/or magnesium ions, boric acid or borates (such as boric oxide, borax and other alkali metal borates); (12) bleaching agents, such as percarbonates (e.g., sodium carbonate peroxyhydrate, sodium pyrophosphate peroxyhydrate, urea peroxyhydrate, and sodium peroxide), persulfates, perborates, magnesium monoperoxyphthalate hexahydrate, the magnesium salt of metachloro perbenzoic acid, 4-nonylamino-4-oxoperoxybutyric acid and diperoxydodecanedioic acid, 6-nonylamino-6-oxoperoxycaproic acid, and photoactivated bleaching agents (e.g., sulfonated zinc and/or aluminum phthalocyanines); (13) bleach activators, such as nonanoyloxybenzene sulfonate (NOBS), tetraacetyl ethylene diamine (TAED), amido-derived bleach activators including (6-octanamidocaproyl)oxybenzenesulfonate, (6-nonanamidocaproyl)oxybenzenesulfonate, (6-decanamidocaproyl)oxybenzenesulfonate, and mixtures thereof, benzoxazin-type activators, acyl lactam activators (especially acyl caprolactams and acyl valerolactams); and (9) any other known detergent adjunct ingredients, including but not limited to carriers, hydrotropes, processing aids, dyes or pigments, and solid fillers.

### Process for Making Structured Detergent Particles

The process of making the structured detergent particles of the present invention, preferably in an agglomerated form, comprising the steps of: (a) providing the raw materials in the weight proportions as defined hereinabove, in either powder and/or paste forms; (b) mixing the raw materials in a mixer or granulator that is operating at a suitable shear force for agglomeration of the raw materials; (c) optionally, removing any oversize particles, which are recycled via a grinder or lump-breaker back into the process stream, e.g., into step (a) or (b); (d) the resulting agglomerates are dried to remove moisture that may be present in excess of 3 wt %, preferably in excess of 2%, and more preferably in excess of 1%; (e) optionally, removing any fines and recycling the fines to the mixer-granulator, as described in step (b); and (f) optionally, further removing any dried oversize agglomerates and recycling via a grinder to step (a) or (e). Preferably, the process is carried out without any subsequent drying step.

Any suitable mixing apparatus capable of handling viscous paste can be used as the mixer described hereinabove for practice of the present invention. Suitable apparatus includes, for example, high-speed pin mixers, ploughshare mixers, paddle mixers, twin-screw extruders, Teledyne compounders, etc. The mixing process can either be carried out intermittently in batches or continuously.

### Process for Making the Granular Detergent Compositions Comprising the Structured Detergent Particles

The granular detergent composition, which is provided in a finished product form, can be made by mixing the structured detergent particles of the present invention with a plurality of other particles containing the above-described surfactants and adjunct materials. Such other particles can be provided as spray-dried particles, agglomerated particles, and extruded particles. Further, the surfactants and adjunct materials can also be incorporated into the granular detergent composition in liquid form through a spray-on process.

### Process for Using the Granular Detergent Compositions for Washing Fabric

The granular detergent compositions of the present invention are suitable for use in both machine-washing and hand-washing context. The laundry detergent is typically diluted by a factor of from about 1:100 to about 1:1000, or about 1:200 to about 1:500 by weight. The wash water used to form the laundry liquor is typically whatever water is easily available, such as tap water, river water, well water, etc. The temperature of the wash water may range from about 0° C. to about 40° C., preferably from about 5° C. to about 30° C., more preferably from 5° C. to 25° C., and most preferably from about 10° C. to 20° C., although higher temperatures may be used for soaking and/or pretreating.

### Test Methods

The following techniques must be used to determine the properties of the detergent granules and detergent compositions of the invention in order that the invention described and claimed herein may be fully understood.

### Test 1: Bulk Density Test

The granular material bulk density is determined in accordance with Test Method B, Loose-fill Density of Granular Materials, contained in ASTM Standard E727-02, “Standard Test Methods for Determining Bulk Density of Granular Carriers and Granular Pesticides,” approved Oct. 10, 2002.

### Test 2: Sieve Test

This test method is used herein to determine the particle size distribution of the agglomerated detergent granule's of the present invention. The particle size distribution of the detergent granules and granular detergent compositions are measured by sieving the granules through a succession of sieves with gradually smaller dimensions. The weight of material retained on each sieve is then used to calculate a particle size distribution.

This test is conducted to determine the Median Particle Size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 μm), #12 (1700 μm), #16 (1180 μm), #20 (850 μm), #30 (600 μm), #40 (425 μm), #50 (300 μm), #70 (212 μm), and #100 (150 μm) is required. The prescribed Machine-Sieving Method is used with the above sieve nest. The detergent granule of interest is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate.

An example of the above data representation is given in ISO 9276-1:1998, “Representation of results of particle size analysis—Part 1: Graphical Representation”, Figure A.4. The Median Weight Particle Size (Dw50) is defined as the abscissa value at the point where the cumulative weight percent is equal to 50 percent, and is calculated by a straight line interpolation between the data points directly above (a50) and below (b50) the 50% value using the following equation:

D_{w}50=10[Log(Dₐ₅₀)−(Log(Dₐ₅₀)−Log(D_{b5o}))*(Qₐ₅ₒ−50%)/(Qₐ₅₀−Q_{bso})]

where Qₐ₅₀ and Q_{b50} are the cumulative weight percentile values of the data immediately above and below the 50^{th} percentile, respectively; and Dₐ₅₀ and D_{b50} are the micron sieve size values corresponding to these data. In the event that the 50^{th} percentile value falls below the finest sieve size (150 μm) or above the coarsest sieve size (2360 μm), then additional sieves must be added to the nest following a geometric progression of not greater than 1.5, until the median falls between two measured sieve sizes.

### Test 3: Laser Diffraction Method

This test method must be used to determine a fine powder's (e.g. raw materials like sodium carbonate and silica) Weight Median Particle Size (Dw50). The fine powder's Weight Median Particle Size (Dw50) is determined in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A.

The results are expressed in accordance with ISO 9276-1:1998, “Representation of results of particle size analysis—Part 1: Graphical Representation”, Figure A.4, “Cumulative distribution Q3 plotted on graph paper with a logarithmic abscissa.” The Median Particle Size is defined as the abscissa value at the point where the cumulative distribution (Q3) is equal to 50 percent.

### Test 4: Silica Particle Size and Swollen Factor Test

The Swollen Factor Test is used to measure swelling of hydrophilic silica on contact with excess water. As a measure of swelling, this method compares the measured particle size distribution of silica hydrated in excess water relative to the measured particle size distribution of the dry silica powder.

Obtain a representative dry powder sample of the silica raw material to be tested.

Measure the dry powder's particle size distribution in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A. The results are expressed in accordance with ISO 9276-1:1998, “Representation of results of particle size analysis—Part 1: Graphical Representation”, Figure A.4, “Cumulative distribution Q3 plotted on graph paper with a logarithmic abscissa.” The Dv10 dry particle size (D10dry) is defined as the abscissa value at the point where the cumulative volumetric distribution (Q3) is equal to 10 percent; the Dv50 dry particle size (D50dry) is defined as the abscissa value at the point where the cumulative volumetric distribution (Q3) is equal to 50 percent; the Dv90 dry particle size (D90dry) is defined as the abscissa value at the point where the cumulative volumetric distribution (Q3) is equal to 90 percent.

Prepare a hydrated silica particle sample by weighing 0.05 g of the representative dry powder sample, and adding it into stirred beaker having 800 ml of deionized water. Using the resultant dispersion of silica hydrogel particles, measure the silica hydrogel's particle size distribution in accordance with ISO 13320-1, “Particle size analysis—Laser diffraction methods.” Suitable laser diffraction particle size analyzers for measurement of the silica hydrogel particle size distribution can be obtained from Horiba Instruments Incorporated of Irvine, Calif., U.S.A.; Malvern Instruments Ltd of Worcestershire, UK; and Beckman-Coulter Incorporated of Fullerton, Calif., U.S.A. The results are expressed in accordance with ISO 9276-1:1998, “Representation of results of particle size analysis—Part 1: Graphical Representation”, Figure A.4, “Cumulative distribution Q3 plotted on graph paper with a logarithmic abscissa.” The Dv10 hydrogel particle size (D10hydro) is defined as the abscissa value at the point where the cumulative volume distribution (Q3) is equal to 10 percent; the Dv50 hydrogel particle size (D50hydro) is defined as the abscissa value at the point where the cumulative volume distribution (Q3) is equal to 50 percent; the Dv90 hydrogel particle size (D90hydro) is defined as the abscissa value at the point where the cumulative volume distribution (Q3) is equal to 90 percent.

The silica's Swollen Factor is calculated as follows:

Swollen Factor=0.2×(D10_{hydro}/D10_{dry})³+0.6×(D50_{hydro}/D50_{dry})³+0.2×(D90_{hydro}/D90_{dry})³

The Dv particle sizes for this example are shown in Table I.

TABLE I

| | Particle size (um) | | |
|---|---|---|---|
| | D10 | D50 | D90 |
| Dry silica particles | 2.08 | 5.82 | 21.01 |
| Silica in water (hydrogel) | 6.75 | 18.57 | 53.7 |

The Swollen Factor for the exemplary silica material described hereinabove, as calculated using the data from Table I, is about 30.

### EXAMPLES

### Example 1

### Comparative Test Showing Percentage Oversized Particle Generated Using Sodium Tripolyphosphate (STPP) or Sodium Carbonate

1.1. WO9804670 discloses in Example VIII a granular detergent composition containing about 30% of HLAS, 36% of sodium carbonate, 29% of sodium tripolyphosphate (STPP), and 5% of a hydrophilic silica. It has been a surprising and unexpected discovery that the structured detergent particles of the present invention, which contain a significantly higher amount of sodium carbonate but with little or no STPP, lead to formation of less oversized particles that are undesirable.
1.2. A first sample (“Comparative Sample”) is made by following steps: 1) 33.98 grams of precipitated silica powder (commercialized by Evonik Industries AG under the 10 trade name SN340) that has a particle size distribution Dw50 of about 6 micron and 2) 244.66 grams of ground sodium carbonate that has a particle size distribution Dw50 of about 20-25 micron and 3) 197.09 grams STPP that has a particle size distribution Dw50 of about 39.5 micron are weighed into the batch Tilt-a-pin mixer (from Processall) and mixed with the mixer running at 700 rpm for about 2 seconds; 4) 224.27 grams paste that is premixed by 203.88 grams 96% active HLAS and 20.39 grams water is injected into the mixer at a rate of about 20.39 grams/sec until all the paste are added; 5) the mixture is then mixed for additional 2 seconds before stopping. Total about 685 grams of final product is made with the raw material proportions described in Table I (15 grams of carbon dioxide are generated and lost).
1.3. A second sample (“Inventive Sample”) is made by following steps: 1) 33.98 grams of precipitated silica powder (commercialized by Evonik Industries AG under the 10 trade name SN340) that has a particle size distribution Dw50 of about 6 micron and 2) 244.66 grams of ground sodium carbonate that has a particle size distribution Dw50 of about 20-25 micron and 3) 197.09 grams Carbonate that has a particle size distribution Dw50 of about 67 micron are weighed into the batch Tilt-a-pin mixer (from Processall) and mixed with the mixer running at 700 rpm for about 2 seconds; 4) 224.27 grams paste that is premixed by 203.88 grams 96% active HLAS and 20.39 grams water is injected into the mixer at a rate of about 20.39 grams/sec until all the paste are added; 5) the mixture is then mixed for additional 2 seconds before stopping. Total about 685 grams of final product is made with the raw material proportions described in Table II (15 grams of carbon dioxide are generated and lost).
1.4. The initial raw material proportions breakdowns of the Comparative Sample and Inventive Sample are tabulated as follows:

TABLE II

| Raw Materials | Comparative Sample | Inventive Sample |
|---|---|---|
| Paste (premix 96% HLAS | 32.04% | 32.04% |
| with 10% water) | | |
| STPP | 28.16% | 0.00% |
| Carbonate | 0.00% | 28.16% |
| Silica | 4.85% | 4.85% |
| Ground Carbonate | 34.95% | 34.95% |
| Total | 100.00% | 100.00% |

1.5. The amount of oversized particles with particle sizes >1180 μm is then measured for both the Inventive Sample and the Comparative Sample. Specifically, the resulting agglomerates are sieved through a 1.18 mm U.S. Standard (ASTM E 11) sieve (#16) for 1 minute. Oversized particles that are retained on the screen and the remaining of the agglomerates that pass through the screen are weighed separately.
1.6. The respective amount of oversized particles in the Comparative Sample or the Inventive Sample is calculated by:

$$\% Oversized = \frac{Weight of Oversized Particles}{\begin{matrix}Weight of Oversized Particles + \\ Weight of the Passed Agglomerates\end{matrix}} \times 100 \%$$

1.7. The measurement results are shown as below:

TABLE III

| | Comparative Sample | Inventive Sample |
|---|---|---|
| Percentage of oversized | 22% | 9% |
| particles (>1180 um) | | |

1.8. The above test results show that the percentage of oversized particles in the Inventive Sample is only half of the Comparative Sample. Therefore, replacement of STPP by sodium carbonate leads to significant reduction of the amount of oversized particles generated.

### Example 2

### Structured Detergent Particles and Composite Detergent Particles

Exemplary structured detergent particles according to the present invention are made by following steps: 1) 34 grams of precipitated silica powder (commercialized by Madhu Silica PVT., Ltd) that has a particle size distribution Dw50 of about 5 micro and 2) 311.4 grams of ground sodium carbonate that have a particle size distribution Dw50 of about 20-25 um and 77.9 gram sodium carbonate are weighed into the batch Tilt-a-pin mixer (from Processall) and mixed with the mixer running at 700 rpm for about 2 seconds; 3) 276.7 grams of HLAS which is 96% active is injected into the mixer at a rate of about 25.2 ml/sec until all the paste are added; 4) The mixture is then mixed for 2 seconds before stopping; Total about 679.7 grams of final product is made with the composition described in Table IV as Particle A (20.3 grams of carbon dioxide are generated and lost).

Exemplary composite detergent particles according to the present invention are made by following steps: 1) 103.4 grams of precipitated hydrophilic silica powder (commercialized by Evonik Industries AG under the 10 trade name SN340) that has a particle size distribution Dw50 of about 6 um and 2) 104.24 grams of ground sodium carbonate that have a particle size distribution Dw50 of about 20-25 um are weighed into the batch Tilt-a-pin mixer (Processall) and mixed with the mixer running at 1200 rpm for about 2 seconds; 3) 79.35 grams of HLAS which is 96% active and 4) 234.79 grams AE1S paste which having a detergent activity of 78% are injected into the mixer in series order at a rate of about 30 ml/sec until all the paste are added; 5) The mixture is then mixed for 2 seconds before stopping and manually transferred to Tilt-a-Plow (Processall); 6) The mixture is then mixed at a rate of 240 rpm for 2 seconds before about 78.26 grams of AE1S paste is pumped into the mixer to form a layer on the agglomerate. 7) The product is then transferred to a batch fluidized bed drier, operating at inlet air velocity of about 0.8 m/s and drying air temperature of about 105° C. until 50.18 grams of water was dried out. Thus 544 grams of final product can be made (5.76 grams of carbon dioxide are generated and lost). The product outcome yields the compositions described in Table IV as Particle B.

Following table shows the compositional makeup of the exemplary structured detergent particles and composite detergent particles:

TABLE IV

| | Particle A | Particle B |
|---|---|---|
| | (Structured | (Composite |
| | Detergent | Detergent |
| Ingredients (wt %) | Particles) | Particles) |
| LAS | 42.00 | 15.00 |
| AE1S* | 0.00 | 45.00 |
| Silica** | 4.75 | 21.00 |
| Ground Sodium | 40.00 | 13.60 |
| carbonate*** | | |
| Sodium carbonate*** | 10.00 | 0.00 |
| Misc. | 1.65 | 2.90 |
| Water | 1.60 | 2.50 |
| Total | 100.00 | 100.00 |

*Made from 78% active NaAE1S paste
**Sipernat ® 340 having a Dw50 of from 4-6 um.
***Sodium carbonate Dw50 is from 60-80 um. Ground sodium carbonate Dw50 is from 10-25 um.

### Example 3

### Exemplary Formulations of Granular Laundry Detergent Compositions

| Ingredient | Amount |
|---|---|
| Particle A | from about 0.5 wt % to about |
| | 20 wt %, preferably 4-12 wt % |
| Particle B | from about 1 wt % to about |
| | 20 wt %, preferably 2-10 wt % |
| Base detergent granules* | from about 50 wt % to about |
| | 90 wt %, preferably 60-80 wt % |
| Amylase (Stainzyme Plus ®, having an enzyme activity | from about 0 wt % to about |
| of 14 mg active enzyme/g) | 0.5 wt % |
| Non-ionic detersive surfactant (such as alkyl | from about 0 wt % to about 4 wt % |
| ethoxylated alcohol) | |
| Cationic detersive surfactant (such as quaternary | from about 0 wt % to about 4 wt % |
| ammonium compounds) | |
| Other detersive surfactant (such as zwiterionic | from about 0 wt % to 4 wt % |
| detersive surfactants, amphoteric surfactants and | |
| mixtures thereof) | |
| Carboxylate polymer (such as co-polymers of maleic | from about 0 wt % to about 4 wt % |
| acid and acrylic acid) | |
| Polyethylene glycol polymer (such as a polyethylene | from about 0 wt % to about 4 wt % |
| glycol polymer comprising poly vinyl acetate side | |
| chains) | |
| Polyester soil release polymer (such as Repel-o-tex | from about 0 wt % to about 2 wt % |
| and/or Texcare polymers) | |
| Cellulosic polymer (such as carboxymethyl cellulose, | from about 0 wt % to about 2 wt % |
| methyl cellulose and combinations thereof) | |
| Other polymer (such as amine polymers, dye transfer | from about 0 wt % to about 4 wt % |
| inhibitor polymers, hexamethylenediamine derivative | |
| polymers, and mixtures thereof) | |
| Zeolite builder and phosphate builder (such as zeolite | from about 0 wt % to about 5 wt % |
| 4A and/or sodium tripolyphosphate) | |
| Other builder (such as sodium citrate and/or citric | from about 0 wt % to about 5 wt % |
| acid) | |
| Carbonate salt (such as sodium carbonate and/or | from about 0 wt % to about |
| sodium bicarbonate) | 30 wt % |
| Silicate salt (such as sodium silicate) | from about 0 wt % to about |
| | 10 wt % |
| Filler (such as sodium sulphate and/or bio-fillers) | from about 10 wt % to about |
| | 40 wt % |
| Source of available oxygen (such as sodium | from about 0 wt % to about |
| percarbonate) | 20 wt % |
| Bleach activator (such as tetraacetylethylene diamine | from about 0 wt % to about 8 wt % |
| (TAED) and/or nonanoyloxybenzenesulphonate | |
| (NOBS) | |
| Bleach catalyst (such as oxaziridinium-based bleach | from about 0 wt % to about |
| catalyst and/or transition metal bleach catalyst) | 0.1 wt % |
| Other bleach (such as reducing bleach and/or pre- | from about 0 wt % to about |
| formed peracid) | 10 wt % |
| Chelant (such as ethylenediamine-N′N′-disuccinic acid | from about 0 wt % to about 1 wt % |
| (EDDS) and/or hydroxyethane diphosphonic acid | |
| (HEDP) | |
| Photobleach (such as zinc and/or aluminium | from about 0 wt % to about |
| sulphonated phthalocyanine) | 0.1 wt % |
| Hueing agent (such as direct violet 99, acid red 52, acid | from about 0 wt % to about |
| blue 80, direct violet 9, solvent violet 13 and any | 0.5 wt % |
| combination thereof) | |
| Brightener (such as brightener 15 and/or brightener 49) | from about 0 wt % to about |
| | 0.4 wt % |
| Protease (such as Savinase, Polarzyme, Purafect, FN3, | from about 0 wt % to about |
| FN4 and any combination thereof, typically having an | 1.5 wt % |
| enzyme activity of from about 20 mg to about 100 mg | |
| active enzyme/g) | |
| Amylase (such as Termamyl ®, Termamyl Ultra ®, | from about 0 wt % to about |
| Natalase ®, Optisize HT Plus ®, Powerase ®, | 0.2 wt % |
| Stainzyme ® and any combination thereof, typically | |
| having an enzyme activity of from about 10 mg to | |
| about 50 mg active enzyme/g) | |
| Cellulase (such as Carezyme ®, Celluzyme ® and/or | from about 0 wt % to about |
| Celluclean ®, typically having an enzyme activity of | 0.5 wt % |
| from 10 to 50 mg active enzyme/g) | |
| Lipase (such as Lipex ®, Lipolex ®, Lipoclean ® and | from about 0 wt % to about 1 wt % |
| any combination thereof, typically having an enzyme | |
| activity of from about 10 mg to about 50 mg active | |
| enzyme/g) | |
| Other enzyme (such as xyloglucanase (e.g., | from 0 wt % to 2 wt % |
| Whitezyme ®, cutinase, pectate lyase, mannanase, | |
| bleaching enzyme, typically having an enzyme activity | |
| of from about 10 mg to about 50 mg active enzyme/g) | |
| Fabric softener (such as montmorillonite clay and/or | from 0 wt % to 15 wt % |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 0.1 wt % |
| Perfume (such as perfume microcapsule, spray-on | from 0 wt % to 1 wt % |
| perfume, starch encapsulated perfume accords, | |
| perfume loaded zeolite, and any combination thereof) | |
| Aesthetics (such as colored soap rings and/or colored | from 0 wt % to 1 wt % |
| speckles/noodles) | |
| Miscellaneous | Balance |

*The base granules are spray-dried detergent particles containing about 12-13 wt % LAS, about 70-75 wt % sodium sulfate, about 8-10 wt % silicate, and less than 3 wt % moisture.

All enzyme levels expressed as rug active enzyme protein per 100 g detergent composition.

Surfactant ingredients can be obtained from BASF, Ludwigshafen, Germany (Lutensol®); Shell Chemicals, London, UK; Stepan, Northfield, Ill., USA; Huntsman, Huntsman, Salt Lake City, Utah, USA; Clariant, Sulzbach, Germany (Praepagen®).

Sodium tripolyphosphate can be obtained from Rhodia, Paris, France.

Zeolite can be obtained from Industrial Zeolite (UK) Ltd, Grays, Essex, UK.

Citric acid and sodium citrate can be obtained from Jungbunzlauer, Basel, Switzerland.

NOBS is sodium nonanoyloxybenzenesulfonate, supplied by Eastman, Batesville, Ark., USA.

TAED is tetraacetylethylenediamine, supplied under the Peractive® brand name by Clariant GmbH, Sulzbach, Germany.

Sodium carbonate and sodium bicarbonate can be obtained from Solvay, Brussels, Belgium.

Polyacrylate, polyacrylate/maleate copolymers can be obtained from BASF, Ludwigshafen, Germany.

Repel-O-Tex® can be obtained from Rhodia, Paris, France.

Texcare® can be obtained from Clariant, Sulzbach, Germany.

Sodium percarbonate and sodium carbonate can be obtained from Solvay, Houston, Tex., USA.

Na salt of Ethylenediamine-N,N′-disuccinic acid, (S,S) isomer (EDDS) was supplied by Octel, Ellesmere Port, UK.

Hydroxyethane di phosphonate (HEDP) was supplied by Dow Chemical, Midland, Mich., USA.

Enzymes Savinase®, Savinase® Ultra, Stainzyme® Plus, Lipex®, Lipolex®, Lipoclean®, Celluclean®, Carezyme®, Natalase®, Stainzyme®, Stainzyme® Plus, Termamyl®, Termamyl® ultra, and Mannaway® can be obtained from Novozymes, Bagsvaerd, Denmark.

Enzymes Purafect®, FN3, FN4 and Optisize can be obtained from Genencor International Inc., Palo Alto, Calif., US.

Direct violet 9 and 99 can be obtained from BASF DE, Ludwigshafen, Germany.

Solvent violet 13 can be obtained from Ningbo Lixing Chemical Co., Ltd. Ningbo, Zhejiang, China.

Brighteners can be obtained from Ciba Specialty Chemicals, Basel, Switzerland.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A structured detergent particle comprising:
(a) from 35 wt % to 50 wt % of an anionic surfactant that is a C₁₀-C₂₀ linear alkyl benzene sulphonate;
(b) from 0.5 wt % to 8 wt % of a hydrophilic silica comprising less than 10 wt % of residue salt;
(c) from 40 wt % to 60 wt % of a water-soluble alkaline metal carbonate; and
(d) from 0 wt % to 5 wt % of a phosphate builder,
wherein said structured detergent particle is characterized by: (1) a particle size distribution Dw50 of from 100 μm to 1000 μm; (2) a bulk density of from 400 to 1000 g/L; and (3) a moisture content of from 0 wt % to 3 wt %, and wherein said structured detergent particle is substantially free of phosphate.

2. The structured detergent particle of claim 1, wherein said C₁₀-C₂₀ linear alkyl benzene sulphonate is substantially neutralized.

3. The structured detergent particle of claim 1, comprising from 40 wt % to 45 wt % of said C₁₀-C₂₀ linear alkyl benzene sulphonate.

4. The structured detergent particle of claim 1, wherein said hydrophilic silica is capable of forming swollen silica particles upon hydration, and wherein said swollen silica particles have a particle size distribution Dv50 of from 1 μm to 100 μm.

5. The structured detergent particle of claim 1, comprising from 2 wt % to 6 wt % of said hydrophilic silica.

6. The structured detergent particle of claim 1, wherein said water-soluble alkali metal carbonate is preferably in a particulate form characterized by a particle size distribution Dw50 ranging from 10 microns to 100 microns.

7. The structured detergent particle of claim 1, wherein said water-soluble alkali metal carbonate is selected from the group consisting of sodium carbonate, sodium bicarbonate, potassium carbonate, potassium bicarbonate, and mixtures thereof.

8. The structured detergent particle of claim 1, comprising from 45 wt % to 55 wt % of said water-soluble alkali metal carbonate.

9. A granular detergent composition, comprising the structured detergent particles of claim 1.

10. The granular detergent composition of claim 9, wherein said structured detergent particles are present in an amount ranging from 0.5% to 20% by total weight of said granular detergent composition.

11. The granular detergent composition of claim 9, further comprising composite detergent particles that comprise a C₁₀-C₂₀ linear alkyl benzene sulphonate surfactant and a C₁₀-C₂₀ linear or branched alkylethoxy sulfate surfactant, wherein said composite detergent particles are characterized by a particle size distribution Dw50 of from 100 μm to 1000 μm and a total surfactant content ranging from 50% to 80% by total weight thereof.

12. The granular detergent composition of claim 11, wherein each of said composite detergent particles comprises a core particle and a coating layer thereover, wherein said core particle comprises a mixture of silica with the C₁₀-C₂₀ linear alkyl benzene sulphonate surfactant.

13. The granular detergent composition of claim 11, wherein said composite detergent particles are present in an amount ranging from 1% to 30% by total weight of said granular detergent composition.

14. The granular detergent composition of claim 11, wherein said composite detergent particles are characterized by a weight ratio of the C₁₀-C₂₀ linear alkyl benzene sulphonate surfactant over the C₁₀-C₂₀ linear or branched alkylethoxy sulfate surfactant that ranges from 3:1 to 1:3.

15. A structured detergent particle consisting essentially of:
(a) from 35 wt % to 50 wt % of an anionic surfactant that is a C₁₀-C₂₀ linear alkyl benzene sulphonate;
(b) from 0.5 wt % to 8 wt % of a hydrophilic silica comprising less than 10 wt % of residue salt; and
(c) from 40 wt % to 60 wt % of a water-soluble alkaline metal carbonate,
wherein said structured detergent particle is characterized by: (1) a particle size distribution Dw50 of from 100 μm to 1000 μm; (2) a bulk density of from 400 to 1000 g/L; and (3) a moisture content of from 0 wt % to 3 wt %, and wherein said structured detergent particle is substantially free of phosphate.
